(19) United States
(12) Patent Application Publication
(10) Pub. No.: US 2025/0373909 A1
(43) Pub. Date: Dec. 4, 2025

(54) SYNTHETIC HYPERLOCAL BROADCAST SYSTEMS AND METHODS

(71) Applicant: Pelmorex Corp., Oakville (CA)

(72) Inventors: Donald Alexander LESLIE, Oakville (CA); Kiko GRUSECKI, Mississauga (CA)

(21) Appl. No.: 19/196,094

(22) Filed: May 1, 2025

Related U.S. Application Data
(60) Provisional application No. 63/652,566, filed on May 28, 2024.

(51) Int. Cl. H04N 21/81; H04N 5/265; H04N 21/8358

(52) U.S. Cl. CPC H04N 21/816; H04N 5/265; H04N 21/8358

(57) ABSTRACT

Systems and methods for automatically creating hyperlocal videos. A script generator generates a script for ingestion into an avatar generator. The avatar generator generates a video segment, which is composited into an output video that includes additional data.

### CROSS-REFERENCE TO RELATED APPLICATIONS

This application claims the benefit of U.S. Provisional Application Ser. No. 63/652,566, filed on May 28, 2024, the entire contents of which are hereby incorporated by this reference.

### TECHNICAL FIELD

The disclosed exemplary embodiments relate to computer-implemented systems and methods for generating and providing video reports.

### BACKGROUND

Weather, climate and other environmental conditions play an important role in our daily lives, impacting numerous aspects of our activities, such as outdoor events, travel and commuting, agricultural practices, construction, emergency preparedness, and more.

Various agencies generate and provide forecasts, current conditions and historical data of atmospheric and other climate and environmental conditions, including temperature, barometric pressure, humidity, air quality, smoke, pollen, allergens, insects or other pests, wind speed, gusts and direction, probability and type of precipitation, rain and snow accumulations, wave height/frequency and water temperature, water currents and tides, and other relevant meteorological and marine variables, over a specific location and time period. For instance, weather reports are generated by meteorological agencies and organizations that utilize advanced weather monitoring systems, satellites, and computational models to analyze, predict and record weather patterns.

### SUMMARY

The following summary is intended to introduce the reader to various aspects of the detailed description, but not to define or delimit any invention.

In at least one broad aspect, there is provided a system for generating a hyperlocal video, the system comprising: at least one database; and at least one computing node operatively coupled to the at least one database, wherein the at least one computing node implements: a script generator configured to generate a script using a generative AI model; an avatar generator configured to generate a video segment based on the script, the video segment comprising an avatar delivering the script; a compositor configured to composite the video segment with additional data to generate an output video; and a delivery module configured to deliver the output video to a delivery device.

In another broad aspect, there is provided a method of generating a hyperlocal video, the method comprising: generating a script using a generative AI model; generating a video segment based on the script, the video segment comprising an avatar delivering the script; compositing the video segment with additional data to generate an output video; and delivering the output video to a delivery device.

In some cases, the at least one database includes a client database.

In some cases, the script generator is further configured to receive client data from the client database, and the generative AI model generates the script to include a script portion based on the client data.

In some cases, the client data includes a location, and the script is customized to the location.

In some cases, the compositor is further configured to receive a background from the client database, and the additional data comprises the background, and wherein the compositing includes overlying the video segment atop the background.

In some cases, the compositor is further configured to receive auxiliary data from the client database, and the additional data comprises the auxiliary data, and the compositing further comprises inserting the auxiliary data into the output video.

In some cases, the auxiliary data comprises a QR code.

In some cases, the compositor is further configured to receive one or more infographic from the at least one database, and the additional data comprises the one or more infographic, and the compositing further comprises inserting the one or more infographic into the output video.

In some cases, the at least one computing node is further configured to implement a watermarker, the watermarker configured to apply a watermark to the output video.

In some cases, the video segment is keyed.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of a computing system in accordance with at least some embodiments;

FIG. 2 is a block diagram of a computer in accordance with at least some embodiments; and

FIG. 3 is a flowchart diagram of an example method for generating a video in accordance with at least some embodiments.

### DETAILED DESCRIPTION

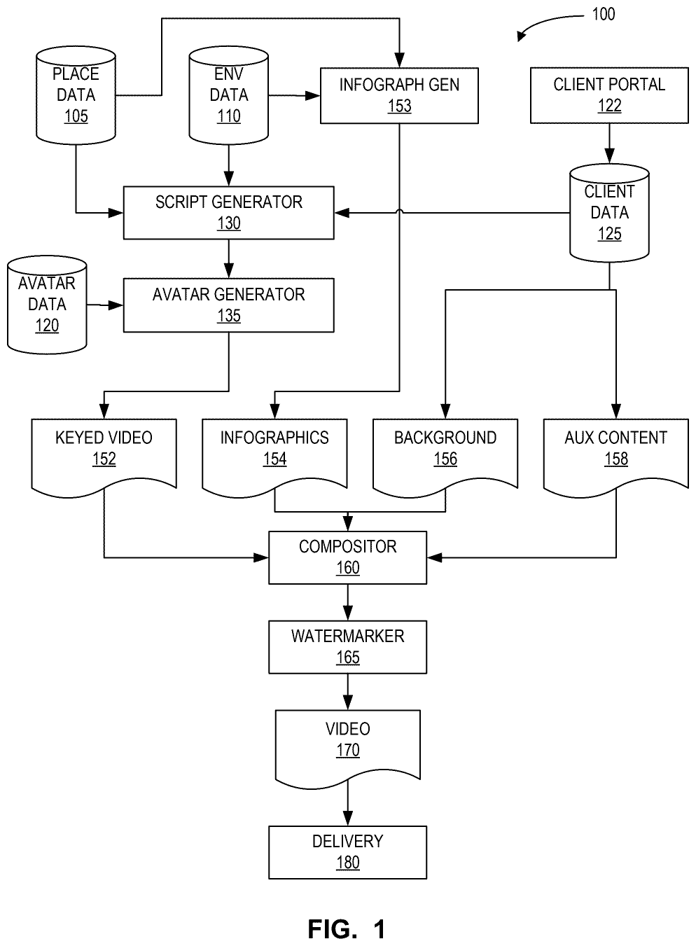

Referring now to FIG. 1, there is illustrated a block diagram of an example computing system, in accordance with at least some embodiments. Computing system 100 has at least one application server 110, at least one resource server 120, at least one data server 150, and at least one user computing device 140, each of which is operatively coupled to a network 190, and thereby to each other. Network 190 may be a public network, such as the internet, or a private or virtual private network, or a mixture of the foregoing. In general, an application server 110 handles interaction with a user or external programmatic interface, while a resource server 120 handles processing of queries. However, in at least some embodiments, application servers 110 and resource server 120 may be interchangeable, with each being capable of performing the functionality of the other. For example, an application server 110 may provide both user interface functionality and query processing functionality.

FIG. 1 is a schematic block diagram of a system 100. System 100 may be implemented as one or more computers, such as in a cloud computing environment, each of which has at least one processor, a memory, and a communication interface.

System 100 has a place or location database 105, an environmental database 110, a client data database 125, and in avatar database 120.

Additionally, system 100 has a script generator 130, an avatar generator 135, a compositor 160, a watermarker module 165, and a delivery module 180. In addition, system 100 may have a client portal 122. All the elements of system 100 are operatively coupled, for example, by a network (not shown so as not to obscure the logical connections of system 100).

The elements of system 100 may be combined or further divided in various ways. For example, place database 105 and environmental database 110 may be implemented as a single database.

Logically, script generator 130 retrieves place data from place database 105. The place data is any data regarding physical locations. For example, a physical location may be a municipality or other geographic location. Place data may include bibliographic and other information regarding the physical location, such as geographic coordinates (e.g., latitude and longitude), a name of the municipality, a population of the municipality, an area of the municipality, governmental information (e.g., names of government officials), time zone, postal codes, notable local trivia, and so forth.

Script generator 130 also retrieves environmental data from environmental database 110. Environmental data may be weather information (which may include historic, current, and forecast weather information). In at least some cases, script generator 130 may first retrieve place information before requesting environmental data for a physical location of interest. Weather information may also include environmental information such as ultraviolet (UV) levels, atmospheric allergens such as pollen, air quality, and so forth. Weather information may also include severe weather warnings and watches.

Script generator 130 also retrieves client data from client database 125. Client data may include information regarding discrete physical locations, including business establishments such as retail stores, restaurants, hotels and healthcare providers. The client data may also include advertising related information, such as advertising assets and targeting information. For example, one client may provide information regarding one or more retail locations, information regarding the goods or services offered at the retail locations, advertising assets associated with the one or more retail locations, and targeting information associated with the one or more retail locations. The targeting information may include both demographic and geographic targeting information. The client data may be provided using client portal 122, which may offer a user interface for adding, updating and managing the client data.

Furthermore, there may be a plurality of clients, each with their own client data. Moreover, each client may have one or more separate campaigns. The described approach may be performed in parallel for each of the plurality of clients and/or campaigns.

Script generator 130 ingests the place data, environmental data and client data, and uses the place data, environmental data and client data to generate one or more scripts. Each script may be associated with a particular physical location. For example, the script may be associated with a municipality or, in some cases, with a single physical location specified in the client data (e.g., a retail location).

In at least some embodiments, the script includes a report associated with the physical location, such as a weather report. A weather report typically includes current weather conditions, such as temperature, humidity, and wind speed, as well as forecasts for the next few hours or days. The script may be generated to give the impression it is being delivered on-location from the physical location, and the report might also include information about the specific area being reported on, such as any notable weather patterns or events that are affecting the community.

The weather report may also provide some context about the current weather situation, such as whether it is a typical day for the time of year or if there are any unusual conditions. It may also include discussion of any potential impacts the weather could have on daily activities, such as commuting to work or school, outdoor events, or travel plans.

In addition to the standard weather information, the report from the physical location may include some unique elements that reflect the specific location and community. For example, a weather report might mention any local weather-related news or concerns, such as flood warnings or severe storm watches, or provide tips on how to stay safe during extreme weather conditions. In at least some cases, the report may incorporate information from the client data, such as information regarding goods or services offered at the physical location, including promotional copy.

The tone of the report may be informal and conversational, with a focus on providing useful and relevant information to recipients who are interested in information regarding their area.

Script generator 130 may be implemented by executing one or more machine learning model, which may also be referred to as a generative artificial intelligence system (AI) or “genAI”. Examples of genAI include a large language model (LLM), such as OpenAI ChatGPT™ or Meta LLAMA. The machine learning model ingests data retrieved by script generator 130, e.g., place data, environmental data and client data, and may generate the script for each report. The machine learning model may be trained or fine-tuned using existing weather reports. Alternatively, or in addition, the prompt used to generate the report may include one or more examples of a report.

In at least some embodiments, the prompt and/or the script may include portions of predetermined text. For example, the predetermined text may be text pre-written by a human author that is included in client data.

The prompt may also suggest a specific timing of the script, such that it can be read at an intelligible speaking cadence within a predetermined interval, such as 15, 30 or 60 seconds, for example. In some cases, the timing may be controlled based on a minimum and maximum word count.

Once the script is generated, avatar generator 135 receives the script and also retrieves an avatar from avatar database 120. Avatars are synthetic actors, which may be artificially generated or may be modeled after real or fictional individuals. Avatar generator 135 generates a video segment of the avatar speaking the script generated by script generator 135. Avatar generator 135 may also use a generative AI custom avatar video generation service. One example of a commercial avatar video generation service is HeyGen™.

The video segment may be generated to facilitate keying. Keying refers to the process of separating a foreground object (e.g., the avatar) from its background, allowing it to be composited over another image or video. This can be done using various techniques, including chroma keying (where a specific color is used as the key) or alpha channel (where a grayscale or transparency mask is used).

Infographic generator 153 may generated one or more infographics 154. Alternatively, or in addition, some infographics may be stored in environmental database 110 or another database.

Infographics 154 are static images or videos that may include information related to a weather report, such as temperature and precipitation patterns over time, wind direction and speed, humidity levels, and atmospheric pressure. These visual aids could also show the movement of high and low-pressure systems, fronts, and other weather features across the region.

Other types of infographics may include maps showing current weather conditions, forecast models, and radar or satellite imagery to illustrate precipitation patterns, storm tracks, and other weather phenomena. Additional graphics that highlight specific weather warnings or advisories, such as flood watches or severe thunderstorm warnings may also be provided.

Still further infographics may provide context about the weather, such as graphs showing temperature trends over the past few days or weeks, or charts illustrating the relationship between atmospheric pressure and precipitation. These visual aids help to make complex weather information more accessible and easier to understand for viewers.

Compositor 160 receives the keyed video segment 152, one or more infographics 154, and background content 156 from client database 125. Optionally, auxiliary content 158 may be received from client database 125.

Background content 156 may include images or videos associated with a physical location. In at least some embodiments, background content 156 may be an image or video that appears to have been filmed at or near a physical location, such as business establishment.

Auxiliary data 158 may be other still images or videos associated with the physical location. In some cases, the auxiliary data may include a quick response (QR) code that can be scanned to obtain additional information regarding the physical location. The QR code may be stored with the client data or may be dynamically generated by a QR code generator (not shown).

Compositor 160 composites the keyed video segment 152 over the background 156 to generate a composite video, which when viewed by a recipient may provide the impression that the avatar is present at the physical location that may be depicted in the background image or video.

Additionally, compositor 160 may composite the infographics 154 and auxiliary content 158 into the composite video. The infographics 154 and auxiliary content 158 may be presented in the foreground or background, or a mix of both.

Compositor 160 may be a batched (e.g., daily) or on-demand (e.g., in response to active weather developments) processor, which may be implemented as a parallel processing system to take advantage of cloud computing elasticity. One example of compositing software that may be used is the FFmpeg multimedia framework.

In some cases, the infographics 154 and auxiliary content 158 may be inserted into, and removed from, the composite video at specific time indices, which may be specified in the script or another configuration file.

Watermarker 165 may apply a digital watermark to the composite video to produce an output video 170. The digital watermark may serve to prevent unauthorized duplication and may also encode metadata into the output video to, e.g., indicate the provenance of the output video 170. One example of a watermarker is the VOS watermarking-as-a-service cloud system from Harmonic, Inc.

Once the output video 170 has been generated, delivery module 180 may store it in a database for subsequent delivery. For example, the output video 170 may be delivered to recipients that satisfy associated targeting information, e.g., using an ad targeting system. Alternatively, or in addition, the output video 170 may be broadcast, e.g., by a television channel or webcast operator, or disseminated via other methods, such as uploading to social media such as Facebook™, YouTube™ or Instagram™.

The described approach may be used to create local or “hyperlocal” videos for locations that lack a traditional camera crew and on-air personnel.

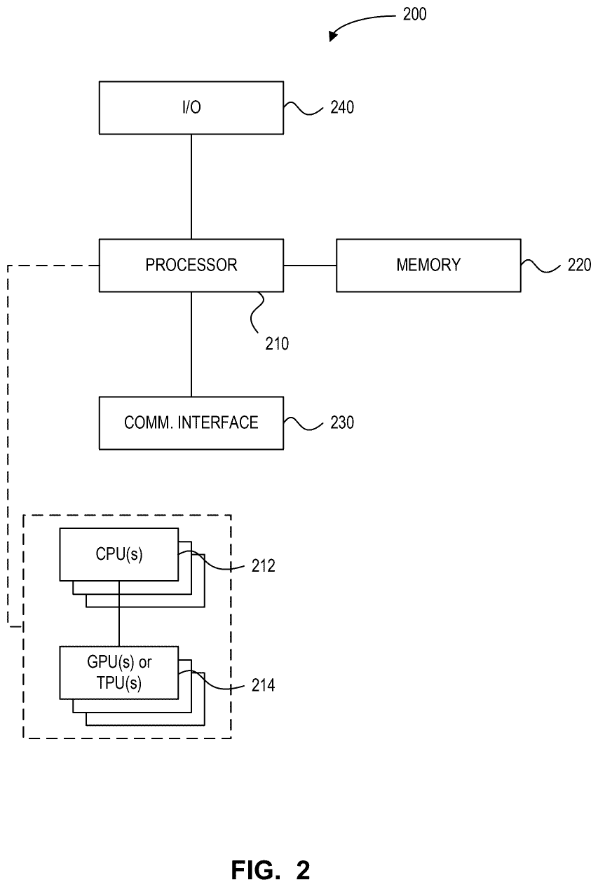

Referring now to FIG. 2, there is illustrated a simplified block diagram of a computer in accordance with at least some embodiments. Computer 200 is an example implementation of a computer such as script generator 130, avatar generator 135, compositor 160, watermarker 165, client portal 122 and delivery module 180 of FIG. 1. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs 212 in combination with one or more processing units capable of high performance vector or floating point processing, such as Graphical Processing Units (GPUs) or Tensor Processing Units (TPUs) 214 that are coupled together. For example, the application server 110 or resource server 120 may execute machine learning model computations on CPU and GPU/TPU hardware, such as the system of CPUs 212 and GPUs/TPUs 214.

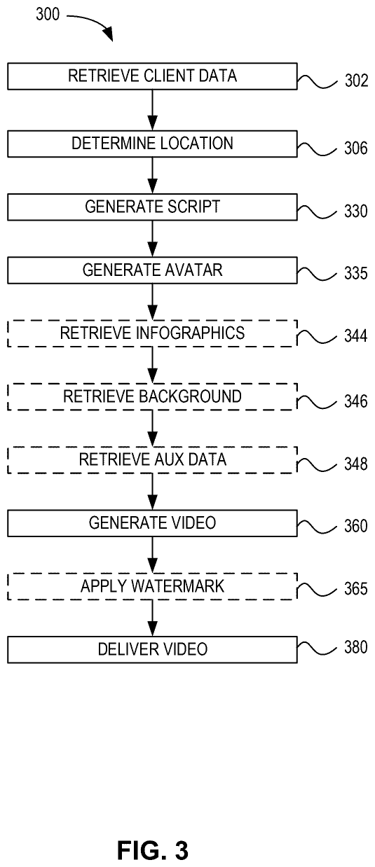

Referring now to FIG. 3, there is illustrated a flow chart diagram for an example process for generating a hyperlocal video, in accordance with at least some embodiments. Process 300 may be carried out, for example, by system 100 of FIG. 1.

Process 300 begins at block 302, by retrieving or receiving client data as described herein.

At block 306, a location is determined based on the client data. As described herein, the location may be a physical location, such as a business establishment.

At block 330, a script is generated using a generative AI model as described herein. The script may include a script portion based on the client data. For example, the script may be customized to the location determined at block 306.

At block 335, a video segment is generated based on the script. The video segment includes an avatar delivering the script as described herein. The video segment may be keyed to facilitate compositing.

Optionally, at blocks 344 to 348, additional data such as one or more infographics, background and/or auxiliary data may be retrieved, as described herein.

At block 360, the video segment is composited with the additional data to generate an output video.

When the additional data includes the background, the compositing includes overlying the video segment atop the background.

When the additional data includes the auxiliary data, the compositing includes inserting the auxiliary data into the output video.

When the additional data includes the one or more infographic, the compositing includes inserting the one or more infographic into the output video.

At block 365, a watermark may be applied to the output video.

At block 380, the output video may be delivered or stored as described elsewhere herein.

The described systems and methods provide for automatically creating hyperlocal videos efficiently on a mass scale using generative AI. The described approach includes: a) creating custom scripts of weather forecast using generative AI for a multitude of different geographical locations or regions at which an advertising partner has a presence or an interest in targeting; b) optionally combining, before, within or after the forecast script, an optionally-localized message script, which is created and combined using generative AI; c) a keyed video of an avatar of either a real person or synthetic person presenting the script from a) and b); e) a background image or video optionally localized and custom to the specific partner location or region, that is combined with the video of the avatar to create the background for the video recording; f) an optional weather data infographic presenting a range of different meteorological parameters for multiple time periods for the location(s) or region of interest for the partner; and g) an optional QR code integrated into the video to enable viewers to easily seek more information.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 1121). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. Further, and in addition to the CPUs described herein, the distributed computing components may also include one or more processing units capable of high performance floating point or vector processing, such as graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for generating a hyperlocal video, the system comprising:
at least one database; and
at least one computing node operatively coupled to the at least one database, wherein the at least one computing node implements:
a script generator configured to generate a script using a generative AI model;
an avatar generator configured to generate a video segment based on the script, the video segment comprising an avatar delivering the script;
a compositor configured to composite the video segment with additional data to generate an output video; and
a delivery module configured to deliver the output video to a delivery device.

2. The system of claim 1, wherein the at least one database includes a client database.

3. The system of claim 2, wherein the script generator is further configured to receive client data from the client database, and wherein the generative AI model generates the script to include a script portion based on the client data.

4. The system of claim 3, wherein the client data includes a location, wherein the script is customized to the location.

5. The system of claim 2, wherein the compositor is further configured to receive a background from the client database, wherein the additional data comprises the background, and wherein the compositing includes overlying the video segment atop the background.

6. The system of claim 1, wherein the compositor is further configured to receive auxiliary data from the client database, wherein the additional data comprises the auxiliary data, and wherein the compositing further comprises inserting the auxiliary data into the output video.

7. The system of claim 6, wherein the auxiliary data comprises a QR code.

8. The system of claim 1, wherein the compositor is further configured to receive one or more infographic from the at least one database, wherein the additional data comprises the one or more infographic, and wherein the compositing further comprises inserting the one or more infographic into the output video.

9. The system of claim 1, wherein the at least one computing node is further configured to implement a watermarker, the watermarker configured to apply a watermark to the output video.

10. The system of claim 1, wherein the video segment is keyed.

11. A method of generating a hyperlocal video, the method comprising:
generating a script using a generative AI model;
generating a video segment based on the script, the video segment comprising an avatar delivering the script;
compositing the video segment with additional data to generate an output video; and
delivering the output video to a delivery device.

12. The method of claim 11, further comprising receiving client data, wherein the generative AI model generates the script to include a script portion based on the client data.

13. The method of claim 12, wherein the client data includes a location, wherein the script is customized to the location.

14. The method of claim 11, further comprising retrieving a background, wherein the additional data comprises the background, and wherein the compositing includes overlying the video segment atop the background.

15. The method of claim 11, further comprising retrieving auxiliary data, wherein the additional data comprises the auxiliary data, and wherein the compositing further comprises inserting the auxiliary data into the output video.

16. The method of claim 11, wherein the auxiliary data comprises a QR code.

17. The method of claim 11, further comprising retrieving one or more infographic, wherein the additional data comprises the one or more infographic, and wherein the compositing further comprises inserting the one or more infographic into the output video.

18. The method of claim 11, further comprising applying a watermark to the output video.

19. The method of claim 11, wherein the video segment is keyed.

20. A non-transitory computer readable medium storing computer executable instructions which, when executed by at least one computer processor, cause the at least one computer processor to carry out a method of generating a hyperlocal video, the method comprising:
generating a script using a generative AI model;
generating a video segment based on the script, the video segment comprising an avatar delivering the script;
compositing the video segment with additional data to generate an output video; and
delivering the output video to a delivery device.
